(19) United States
(12) Patent Application Publication
(10) Pub. No.: US 2006/0268029 A1
(43) Pub. Date: Nov. 30, 2006

(54) Apparatus and method for transmitting print data to inkjet printhead

(75) Inventor: Eog-kyu Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/441,044

(22) Filed: May 26, 2006

(30) Foreign Application Priority Data
May 27, 2005 (KR) 10-2005-0045203

(51) Int. Cl. B41J 29/38

(52) U.S. Cl. 347/9

(57) ABSTRACT

An apparatus and method for transmitting print data to an inkjet printhead are provided, in which a first signal conversion unit which converts print data into an analog signal; a first connection line transmits the analog signal to the inkjet printhead; and a second signal conversion unit converts the analog signal into a digital signal. The inkjet printhead ejects ink according to the digital signal. Accordingly, an image may be quickly formed by transmitting print data to an inkjet printhead regardless of the inkjet printhead adopting a single line ink ejection approach or a multiple line ink ejection approach.

### CROSS-REFERENCE TO RELATED PATENT APPLICATION

This application claims the benefit under 35 U.S.C. §119(a) of Korean Patent Application No. 10-2005-0045203, filed on May, 27, 2005, in the Korean Intellectual Property Office, the entire disclosure of which is hereby incorporated by reference.

### BACKGROUND OF THE INVENTION

1. Field of the Invention

The present invention relates to an inkjet printer. More particularly, the present invention relates to an apparatus and method for transmitting print data to an inkjet printhead of an inkjet printer.

2. Description of the Related Art

FIG. 1 is a block diagram of a conventional apparatus for transmitting print data to an inkjet printhead 30. Referring to FIG. 1, a power supply 10 supplies power to a main board 20 and the inkjet printhead 30. A first controller in which a main controller for controlling an entire inkjet printer system is included in the main board 20 and includes a print data conversion unit and a data transmission unit which transmits print data to the inkjet printhead 30. A second controller, which is included in the inkjet printhead 30 that ejects ink, controls the ejection of ink based on the print data transmitted by the first controller.

For example, when computer outputs print data to an inkjet printer, the print data is transmitted to a first controller of the inkjet printer via an interface unit, such as a universal serial bus (USB), which supports both the computer and the printer. The first controller converts the print data into inkjet-printable data in a predefined format and transmits the inkjet-printable data to a second controller. The second controller ejects ink and prints the inkjet-printable data transmitted by the first controller on paper.

FIGS. 2A and 2B are diagrams illustrating two types of inkjet printheads, such as, a single line inkjet printhead that ejects ink on a single line basis and a multiple line inkjet printhead that ejects ink on a multiple line basis. For example, FIG. 2A illustrates the ejecting of ink on a single line basis by an inkjet printhead that moves laterally, and FIG. 2B illustrates the ejecting of ink on a multiple line basis by an inkjet printhead that moves along a direction in which print paper is transferred. The printing speed of an inkjet printhead is much higher when adopting a multiple line ink ejection approach as illustrated in FIG. 2B than when adopting a single line ink ejection approach as illustrated in FIG. 2A. If the inkjet printhead 30 adopts the single line ink ejection approach as illustrated in FIG. 2A, the transmission speed of the first controller of the main board 20 may not considerably affect the printing speed of the inkjet printhead 30 because the printing speed of the inkjet printhead 30 would be relatively low. However, if the inkjet printhead 30 adopts the multiple line ink ejection approach as illustrated in FIG. 2B, the transmission speed of the first controller of the main board 20 may considerably lower the printing speed of the inkjet printhead 30 because the transmission speed of the first controller of the main board 20 would be much lower than the ink ejection speed of the inkjet printhead 30.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus for transmitting print data to an inkjet printhead which can assist an inkjet printhead to quickly print an image by transmitting print data to the inkjet printhead.

The present invention also provides a method of transmitting print data to an inkjet printhead which can assist an inkjet printhead to quickly print an image by transmitting print data to the inkjet printhead.

According to an aspect of exemplary embodiments of the present invention, there is provided, an apparatus for transmitting print data to an inkjet printhead, in which a first signal conversion unit converts print data into an analog signal; a first connection line transmits the analog signal to the inkjet printhead; and a second signal conversion unit converts the analog signal into a digital signal. The inkjet printhead ejects ink according to the digital signal.

According to another aspect of exemplary embodiments of the present invention, there is provided an apparatus for transmitting print data to an inkjet printhead, in which a third signal conversion unit converts print data into an analog signal; a second connection line connects a power supply and an inkjet printhead; and a fourth signal conversion unit converts an analog signal received via the second connection line into a digital signal. The third signal conversion unit and the second connection line are connected to each other, the second connection line and the fourth signal conversion unit are connected to each other, and the inkjet printhead ejects ink according to the digital signal.

According to another aspect of exemplary embodiments of the present invention, there is provided a method for transmitting print data to an inkjet printhead, in which print data is converted into an analog signal; the analog signal is transmitted to an inkjet printhead; and the analog signal is converted into a digital signal. The inkjet printhead ejects ink according to the digital signal.

According to another aspect of exemplary embodiments of the present invention, there is provided a method for transmitting print data to an inkjet printhead, in which print data is converted into an analog signal; the analog signal is transmitted to an inkjet printhead via a connection line connecting a power supply and the inkjet printhead; and the analog signal is converted into a digital signal. The inkjet printhead ejects ink according to the digital signal.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram of a conventional apparatus for transmitting print data to an inkjet printhead;

FIGS. 2A and 2B are diagrams of an inkjet printhead that ejects ink on a single line basis and an inkjet printhead that ejects ink on a multiple line basis;

FIG. 3 is a block diagram of an apparatus for transmitting print data to an inkjet printhead according to an exemplary embodiment of the present invention;

FIG. 4 is a block diagram of an apparatus for transmitting print data to an inkjet printhead according to an exemplary embodiment of the present invention;

FIG. 5 is a diagram illustrating the waveform of an analog signal superposed on a direct current;

FIG. 6 is a flowchart illustrating a method of transmitting print data to an inkjet printhead according to an exemplary embodiment of the present invention; and

FIG. 7 is a flowchart illustrating a method of transmitting print data to an inkjet printhead according to an exemplary embodiment of the present invention.

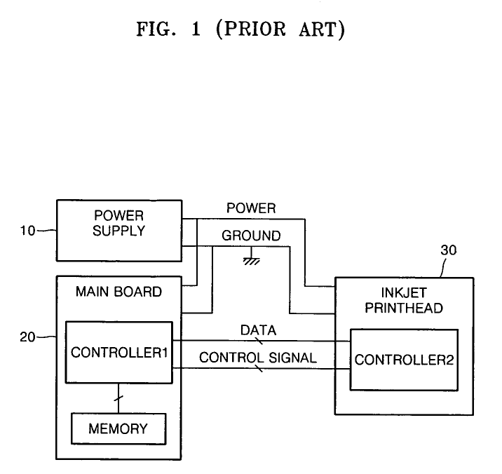

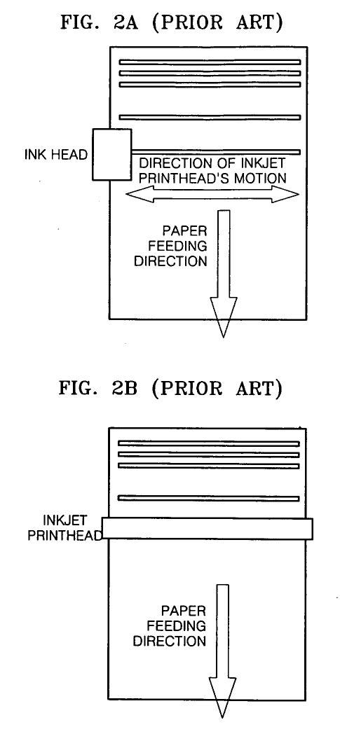

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

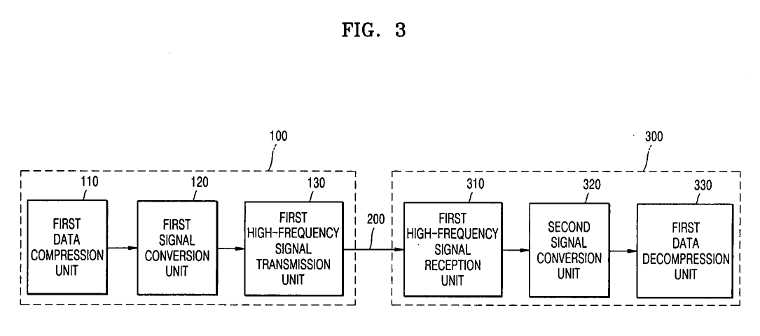

FIG. 3 is a block diagram of an apparatus for transmitting print data to an inkjet printhead according to an exemplary embodiment of the present invention. Referring to FIG. 3, the apparatus includes a main board 100 of an inkjet printer, a first connection line 200, and an inkjet printhead 300.

The main board 100 includes a first data compression unit 110, first signal conversion unit 120, a first high-frequency signal transmission unit 130.

The first data compression unit 110 compresses print data to be transmitted to the inkjet printhead 300 and outputs the compressed print data to the first signal conversion unit 120.

The first signal conversion unit 120 converts the compressed print data into an analog signal and outputs the analog signal to the first high-frequency signal transmission unit 130. The first signal conversion unit 120 may be a digital-to-analog converter.

The first high-frequency signal transmission unit 130 modulates the analog signal transmitted by the first signal conversion unit 120 into a high-frequency analog signal and transmits the high-frequency analog signal to the inkjet printhead 300. Therefore, the first high-frequency signal transmission unit 130 may minimize signal distortion by modulating the analog signal transmitted by the first signal conversion unit 120 into a high-frequency analog signal.

The first connection line 200 is a path which the high-frequency analog signal is output by the first high-frequency signal transmission unit 130 and transmitted to the inkjet printhead 300. Conventionally, a plurality of connection lines is required to transmit print data to an inkjet printhead. On the other hand, in an exemplary implementation, print data corresponding to the high-frequency analog signal output by the first high-frequency signal transmission unit 130 can be transmitted to the inkjet printhead 300 via the first connection line 200.

The inkjet printhead 300 includes a first high-frequency signal reception unit 310, second signal conversion unit 320, and a first data decompression unit 330.

The first high-frequency signal reception unit 310 receives a high-frequency analog signal and outputs the received high-frequency analog signal to the second signal conversion unit 320. For example, the first high-frequency signal reception unit 310 receives the high-frequency analog signal transmitted by the main board 100 via the first connection line 200. The first high-frequency signal reception unit 310 may have frequency information specifying a band of frequencies of signals that can be transmitted by the first high-frequency signal transmission unit 130.

The second signal conversion unit 320 converts the high-frequency analog signal received by the first high-frequency signal reception unit 310 into a digital signal and outputs the digital signal to the first data decompression unit 330. The second signal conversion unit 320 may be an analog-to-digital converter.

The first data decompression unit 330 decompresses compressed print data.

The inkjet head 300 prints the recovered print data by ejecting ink.

The apparatus as illustrated in FIG. 3 may be applied to an inkjet printhead adopting a single line ink ejection approach and to an inkjet printhead adopting a multiple line ink ejection approach. The apparatus, as illustrated in FIG. 3, may achieve a high transmission speed and is suitable for an inkjet printhead adopting the multiple line ink ejection approach.

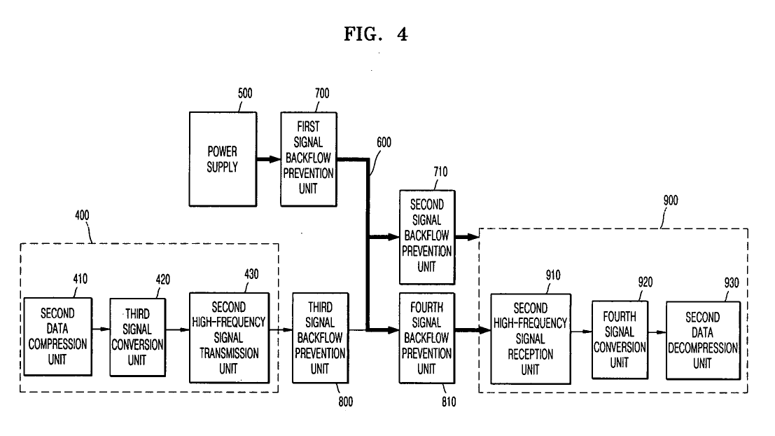

FIG. 4 is a block diagram of an apparatus for transmitting print data to an inkjet printhead according to an exemplary embodiment of the present invention. Referring to FIG. 4, the apparatus includes a main board 400 of an inkjet printer, power supply 500, second connection line 600, first signal backflow prevention unit 700, second signal backflow prevention unit 710, third signal backflow prevention unit 800, fourth signal backflow prevention unit 810, and inkjet printhead 900.

The main board 400 includes a second data compression unit 410, a third signal conversion unit 420, and second high-frequency signal transmission unit 430.

The second data compression unit 410 compresses print data to be transmitted to the inkjet printhead 900 and transmits the compressed print data to the third signal conversion unit 420.

The third signal conversion unit 420 converts the compressed print data into an analog signal and transmits the analog signal to the second high-frequency signal transmission unit 430. The third signal conversion unit 420 may be a digital-to-analog converter.

The second high-frequency signal transmission unit 430 modulates the analog signal transmitted by the third signal conversion unit 420 into a high-frequency analog signal and transmits the high-frequency analog signal to the inkjet printhead 900. Therefore, the second high-frequency signal transmission unit 430 may minimize signal distortion by modulating the analog signal transmitted by the third signal conversion unit 420 into a high-frequency analog signal.

The second connection line 600 is connected to the second high-frequency signal transmission unit 430 for transmitting the high-frequency analog signal output by the second high-frequency signal transmission unit 430 to the inkjet printhead 900. The second connection line 600 mainly acts as a power supply path via which power supplied by the power supply 500 is transmitted to the inkjet printhead 900. In an exemplary implementation, the second connection line 200 also serves as a signal transmission path via which the high-frequency analog signal output by the second high-frequency signal transmission unit 430 is transmitted to the inkjet printhead 900.

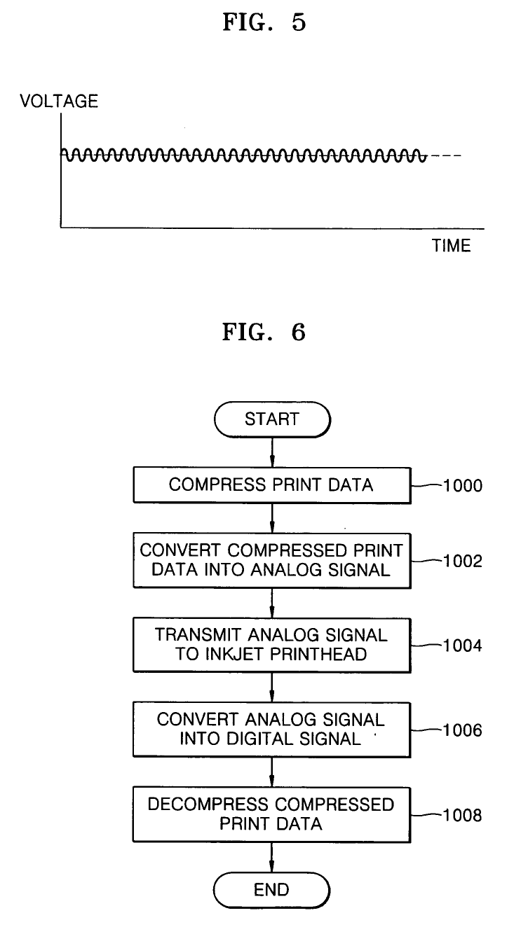

FIG. 5 is a diagram illustrating the waveform of an analog signal superposed on a direct current. Referring to FIG. 5, an analog signal provided by the main board 400 is superposed on a direct current supplied by the power supply 500, and the superposed result is transmitted to the inkjet printhead 900 via the second connection line 600.

In an exemplary implementation, the analog signal is transmitted to the inkjet printhead 900 via the second connection line 600 without the need to provide an additional connection line for transmitting the analog signal to the inkjet printhead 900, thus not incurring an additional connection line installation cost.

The first signal backflow prevention unit 700 is provided at one end of the second connection line 600 near the power supply 500 so that the analog signal may be prevented from flowing into the power supply 500 during transmission to the inkjet printhead 900. If the power supply 500 supplies a direct current, the first signal backflow prevention unit 700 may prevent the analog signal, which is an alternating current, from flowing into the power supply 500 by using an inductor.

The second signal backflow prevention unit 710 is provided at the other end of the second connection line 600 near the inkjet printhead 900 so that the analog signal can be prevented from flowing into a power supply reception port (not shown) of the inkjet printhead 900 in the middle of being transmitted to the inkjet printhead 900. If the power supply 500 supplies a direct current, the second signal backflow prevention unit 710 may prevent the analog signal, which is an alternating current, from flowing into the power supply reception port of the inkjet printhead 900 by using an inductor.

The third signal backflow prevention unit 800 is provided between the second connection line 600 and the second high-frequency signal transmission unit 430 so that the power supplied by the power supply 500 can be prevented from flowing into the second high-frequency signal transmission unit 430 of the main board 400. Since the analog signal provided by the main board 400 is an alternating current, the third signal backflow prevention unit 800 can prevent the power supplied by the power supply 500, which is a direct current, from flowing into the main board 400 by using a capacitor.

The fourth signal backflow prevention unit 810 is provided between the second connection line 600 and a second high-frequency signal reception unit 910 of the inkjet printhead 900 so that the power supplied by the power supply 500 may be prevented from flowing into the second high-frequency signal reception unit 910. Since the analog signal provided by the main board 400 is an alternating current, the fourth signal backflow prevention unit 810 may prevent the power supplied by the power supply 500, which is a direct current, from flowing into the second high-frequency signal reception unit 910 of the inkjet printhead 900.

The inkjet printhead 900 includes the second high-frequency signal reception unit 910, fourth signal conversion unit 920, and second data decompression unit 930.

The second high-frequency signal conversion unit 910 receives a high-frequency analog signal and outputs the received high-frequency analog signal to the second signal conversion unit 920. For example, the second high-frequency signal reception unit 910 receives a high-frequency analog signal transmitted by the main board 400 via the second connection line 600. The second high-frequency signal reception unit 910 must have frequency information specifying a band of frequencies of signals that can be transmitted by the second high-frequency signal transmission unit 430.

The fourth signal conversion unit 920 converts the high-frequency analog signal received by the second high-frequency signal reception unit 910 into a digital signal and outputs the digital signal to the second data decompression unit 930. The fourth signal conversion unit 920 may be an analog-to-digital converter.

The second data decompression unit 930 decompresses compressed print data.

The inkjet printhead 900 prints the print data recovered by ejecting ink.

The apparatus as illustrated in FIG. 4 can be applied to an inkjet printhead adopting a single line ink ejection approach and to an inkjet printhead adopting a multiple line ink ejection approach.

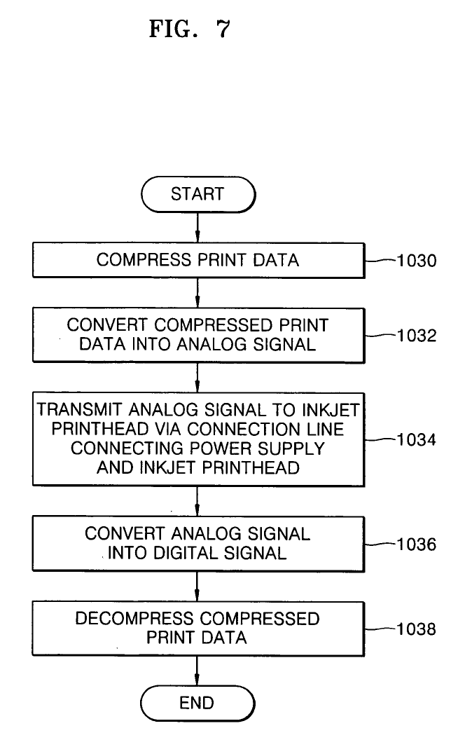

A method of transmitting print data to an inkjet printhead according to an exemplary embodiment of the present invention will now be described in detail with reference to FIGS. 6 and 7.

FIG. 6 is a flowchart illustrating a method of transmitting print data to an inkjet printhead according to an exemplary embodiment of the present invention. Referring to FIG. 6, in operation 1000, print data to be transmitted to an inkjet printhead is compressed. In operation 1002, the compressed print data is converted into an analog signal. In operation 1004, the analog signal is transmitted to the inkjet printhead. In operation 1004, the analog signal may be modulated into a high-frequency analog signal, and then the high-frequency analog signal may be transmitted to the inkjet printhead, thereby minimizing signal distortion.

In operation 1006, the high-frequency analog signal is converted into a digital signal.

In operation 1008, the compressed print data is decompressed from the digital signal. Thereafter, the inkjet head prints the recovered print data by ejecting ink. The method as illustrated in FIG. 6 can be applied to an inkjet printhead adopting a single line ink ejection approach and to an inkjet printhead adopting a multiple line ink ejection approach.

FIG. 7 is a flowchart illustrating a method of transmitting print data to an inkjet printhead according to an exemplary embodiment of the present invention. Referring to FIG. 7, in operation 1030, print data to be transmitted to an inkjet printhead is compressed. In operation 1032, the compressed print data is converted into an analog signal. In operation 1034, the analog signal is transmitted to the inkjet printhead via a connection line connecting power supply and the inkjet printhead. In operation 1034, the analog signal may be modulated into a high-frequency analog signal, and then the high-frequency analog signal may be transmitted to the inkjet printhead via the connection line, thereby minimizing signal distortion.

In operation 1036, the high-frequency analog signal is converted into a digital signal.

In operation 1038, the compressed print data is decompressed from the digital signal. Thereafter, the inkjet head prints the recovered print data by ejecting ink. The method as illustrated in FIG. 7 can be applied to an inkjet printhead adopting a single line ink ejection approach and to an inkjet printhead adopting a multiple line ink ejection approach.

The exemplary embodiments of the present invention may be implemented as computer-readable code or instructions, or a computer program written on a computer-readable recording medium. The computer-readable recording medium may be any type of recording device in which data is stored in a computer-readable manner. Examples of the computer-readable recording medium include a ROM, RAM, CD-ROM, a magnetic tape, floppy disc, optical data storage, and carrier wave ( for example, data transmission through the Internet). The computer-readable recording medium may be distributed over a plurality of computer systems connected to a network so that a computer-readable code is written thereto and executed therefrom in a decentralized manner. Functional programs, code, and code segments needed for implementing the present invention can be easily construed by one of ordinary skill in the art.

As described above, according to exemplary embodiments of the present invention, an image may be quickly formed by transmitting print data to an inkjet printhead regardless of whether the inkjet printhead adopts a single line ink ejection approach or a multiple line ink ejection approach.

In addition, the number of signal lines connecting the inkjet printhead and a main board may be minimized by superposing an analog signal on power supplied for driving the inkjet printhead and transmitting the superposed result to the inkjet printhead.

While the invention has been shown and described with reference to certain exemplary embodiments thereof, it will be understood by those skill in the art that various changes in form and details may be made therein without departing from the spirit and scope of the present invention as defined by the appended claims.

What is claimed is:

1. An apparatus for transmitting print data to an inkjet printhead comprising:
a first signal conversion unit for converting print data into an analog signal;
a first connection line for transmitting the analog signal to the inkjet printhead; and
a second signal conversion unit for converting the analog signal into a digital signal,
wherein the inkjet printhead ejects ink according to the digital signal.

2. The apparatus of claim 1 further comprising:
a first data compression unit for compressing the print data; and
a first data decompression unit for decompressing the compressed print data.

3. The apparatus of claim 1 further comprising:
a first high-frequency signal transmission unit for modulating the analog signal into a high-frequency analog signal and transmitting the high-frequency analog signal; and
a first high-frequency signal reception unit for receiving the high-frequency analog signal transmitted by the first high-frequency signal transmission unit.

4. An apparatus for transmitting print data to an inkjet printhead comprising:
a third signal conversion unit for converting print data into an analog signal;
a second connection line for connecting a power supply and an inkjet printhead; and
a fourth signal conversion unit for converting an analog signal received via the second connection line into a digital signal,
wherein the third signal conversion unit and the second connection line are connected to each other, the second connection line and the fourth signal conversion unit are connected to each other, and the inkjet printhead ejects ink according to the digital signal.

5. The apparatus of claim 4, further comprising a first signal backflow prevention unit which is provided at one end of the second connection line for preventing the analog signal from flowing into the power supply.

6. The apparatus of claim 4, further comprising a second signal backflow prevention unit which is provided at another end of the second connection line for preventing the analog signal from flowing into a power supply reception port of the inkjet printhead.

7. The apparatus of claim 4, further comprising a third signal backflow prevention unit which is provided between the second connection line and the third signal conversion unit for preventing power supplied by the power supply from flowing into the third signal conversion unit.

8. The apparatus of claim 4, further comprising a fourth signal backflow prevention unit which is provided between the second connection line and the fourth signal conversion unit for preventing the power supplied by the power supply from flowing into the fourth signal conversion unit.

9. The apparatus of claim 4, further comprising:
a second data compression unit for compressing the print data; and
a second data decompression unit for decompressing the compressed print data from the digital signal.

10. The apparatus of claim 4, further comprising:
a second high-frequency signal transmission unit for modulating the analog signal into a high-frequency analog signal and transmitting the high-frequency analog signal; and
a second high-frequency signal reception unit for receiving the high-frequency analog signal transmitted by the second high-frequency signal transmission unit.

11. A method of transmitting print data to an inkjet printhead comprising:
converting print data into an analog signal;
transmitting the analog signal to an inkjet printhead; and
converting the analog signal into a digital signal,
wherein the inkjet printhead ejects ink according to the digital signal.

12. The method of claim 1 1, further comprising:
compressing the print data, before the converting of the print data into the analog signal; and
decompressing the compressed print data after the converting of the analog signal into the digital signal.

13. The method of claim 11, wherein the transmitting comprises modulating the analog signal into a high-frequency analog signal and transmitting the high-frequency analog signal.

14. A computer-readable recording medium storing a computer program for executing the method of claim 11.

15. A computer-readable recording medium storing a computer program for executing the method of claim 12.

16. A method of transmitting print data to an inkjet printhead comprising:
converting print data into an analog signal;
transmitting the analog signal to an inkjet printhead via a connection line connecting a power supply and the inkjet printhead; and
converting the analog signal into a digital signal,
wherein the inkjet printhead ejects ink according to the digital signal.

17. The method of claim 16, further comprising:
compressing the print data, before the converting of the print data into the analog signal; and
decompressing the compressed print data after the converting of the analog signal into the digital signal.

18. The method of claim 16, wherein the transmitting comprises modulating the analog signal into a high-frequency analog signal and transmitting the high-frequency analog signal.

19. A computer-readable recording medium storing a computer program for executing the method of claim 16.

20. A computer-readable recording medium storing a computer program for executing the method of claim 17.
